(19) United States
(12) Patent Application Publication
(10) Pub. No.: US 2011/0233173 A1
(43) Pub. Date: Sep. 29, 2011

(54) SEAM WELDING METHOD AND MACHINE THEREFOR

(75) Inventors: Mitsugu Kaneko, Utsunomiya-shi (JP); Eisaku Hasegawa, Kanuma-shi (JP); Akira Goto, Utsunomiya-shi (JP)

(73) Assignee: HONDA MOTOR CO., LTD., Tokyo (JP)

(21) Appl. No.: 13/052,383

(22) Filed: Mar. 21, 2011

(30) Foreign Application Priority Data
Mar. 23, 2010 (JP) 2010-066004

(51) Int. Cl. B23K 11/08

(52) U.S. Cl. 219/83

(57) ABSTRACT

A seam welding machine includes a first roller electrode and a second roller electrode that hold a layered body formed by layering a plurality of workpieces. The first roller electrode is in contact with a thinnest workpiece, which is disposed on an outermost side of the layered body. The seam welding machine has a current-branching electrode held in contact with the thinnest workpiece, and which is charged with a polarity opposite to that of the first roller electrode. Accordingly, when an electric current is applied between the first roller electrode and the second roller electrode that hold the layered body, a branch electric current is applied from the first roller electrode to the current-branching electrode, or a branch electric current is applied from the current-branching electrode to the first roller electrode.

### CROSS-REFERENCE TO RELATED APPLICATION

This application is based upon and claims the benefit of priority from Japanese Patent Application No. 2010-066004 filed on Mar. 23, 2010, of which the contents are incorporated herein by reference.

### BACKGROUND OF THE INVENTION

1. Field of the Invention

The present invention relates to a seam welding method as well as to a machine therefor, for seam welding a layered body produced by layering three or more workpieces, with a thinnest workpiece having the smallest thickness being disposed on an outermost side thereof.

2. Description of the Related Art

Seam welding is widely known as a method for bonding metal plates. As disclosed in Japanese Laid-Open Patent Publication No. 2007-167896 and Japanese Utility Model Registration No. 3124033, during seam-welding, after layered metal plates (which form a layered body) are held between a pair of roller electrodes, an electric current is applied between the roller electrodes. In other words, an electric path is formed in the layered body along the layering direction thereof. It should be understood that the electric current departing from a positive electrode reaches to a negative electrode after sequentially passing through the metal plate that is in contact with the positive electrode, a contact face formed between the metal plates that are in contact with each other, and the metal plate that is in contact with the negative electrode.

While the electrodes are energized, resistance heating occurs at a portion near the contact face, which acts to melt the portion.

Subsequently, the electric path is moved in accordance with movement of the layered body relative to the roller electrodes, so as to shift the portion of the layered body at which resistance heating occurs. More specifically, electric current goes away from the portion that has been melted before movement thereof, so that resistance heating at that portion is terminated. As a result, the temperature of the portion is lowered and the portion becomes solidified (i.e., is placed in a solid phase). The solidified portion frequently is referred to as a nugget.

On the other hand, at a portion corresponding to the new electric path, the portion near the contact face formed by the metal plates that are in contact with each other is melted in a manner similar to that described above.

The above procedure is repeated sequentially in order to bond the metal plates continuously.

In some cases, it is required to bond three or more metal plates. Thicknesses of the metal plates need not necessarily be the same, and they are usually different. In other words, the plural metal plates include a workpiece having the smallest thickness (sometimes referred to as a thinnest workpiece).

When the layered body is seam-welded with the thinnest workpiece being disposed on an outermost side of the layered body, the nugget, which resides between the thinnest workpiece and another workpiece adjacent to the thinnest workpiece, may not grow sufficiently. It is conjectured that this occurs because sufficient resistance heating is not generated, due to the occurrence of a smallest specific resistance as a result of the smallest thickness of the thinnest workpiece.

In order for the nugget to grow sufficiently near the thinnest workpiece, it is conceivable to increase the current value. However, in this case, so-called spattering (scattering of the melted workpiece) is likely to occur.

### SUMMARY OF THE INVENTION

In broad terms, an object of the present invention is to provide a seam welding method that can cause a nugget to grow sufficiently between a thinnest workpiece, which is disposed on an outermost side of a layered body, and another workpiece adjacent to the thinnest workpiece.

Another object of the present invention is to provide a seam welding method, which can avoid generation of spattering.

Yet another object of the present invention is to provide a seam welding machine, which is adapted to perform the above-mentioned seam welding method.

A seam welding method according to an aspect of the present invention is applied for seam-welding a layered body provided by layering three or more workpieces, a thinnest workpiece of the workpieces and having a smallest thickness being disposed on an outermost side of the layered body, the method including the steps of holding the layered body between a first roller electrode and a second roller electrode and bringing a current-branching electrode into contact with the thinnest workpiece, the current-branching electrode being charged with a polarity that is opposite to a polarity of the first roller electrode that is in contact with the thinnest workpiece, and, while moving the first roller electrode, the second roller electrode and the current-branching electrode relative to the layered body, applying an electric current between the first roller electrode and the second roller electrode to thereby seam-weld the layered body, and applying a branch electric current from the first roller electrode to the current-branching electrode or from the current-branching electrode to the first roller electrode.

In other words, the layered body is not only held by the first roller electrode and the second roller electrode, but also is held in contact with the current-branching electrode at the thinnest workpiece upon application of the electric current. Since the first roller electrode, which is held in contact with the thinnest workpiece in conjunction with the current-branching electrode, is charged with a polarity opposite to that of the current-branching electrode, at least one electric current is generated from among the electric current branched from the first roller electrode toward the current-branching electrode, and the electric current that flows in a reverse direction thereto. The branch electric current flows inside the thinnest workpiece, whereby the interface between the thinnest workpiece and one of the workpieces adjacent to the thinnest workpiece is sufficiently heated.

Since the layered body is heated by the branch electric current, a nugget, which is sufficiently large in size, grows at the interface. Thus, a bonding portion exhibiting excellent bonding strength can be obtained.

Further, in this case, the electric current that flows in the remaining workpieces becomes small as compared with conventional seam welding, in which only the first roller electrode and the second roller electrode holds the layered body upon application of electric current thereto. Thus, generation of spattering does not occur before nuggets, which are formed at the interface, grow sufficiently large in size.

As described above, according to the present invention, nuggets, which are sufficiently large in size, can be grown between the thinnest workpiece, which is disposed on the outermost side of the layered body, and the workpiece adjacent to the thinnest workpiece. In addition, generation of spattering can be avoided.

Incidentally, during the above process, when a nugget is not formed, or does not grow sufficiently large at the interface between the remaining workpieces, electric current may continue to be applied between the first roller electrode and the second roller electrode after only the current-branching electrode becomes spaced apart from the thinnest workpiece, or if the electric path between the current-branching electrode and the power source is disconnected. In order to disconnect the electric path between the current-branching electrode and the power source, a switch may be provided between the current-branching electrode and the power source, and the switch may be turned off.

Since the branch electric current disappears when the current-branching electrode is separated or if the electric path is disconnected, heat generated on account of Joule heating in the thinnest workpiece is reduced. Consequently, growth of the nugget formed between the thinnest workpiece and the workpiece adjacent thereto slows down. On the other hand, the electric current flowing in the remaining workpieces is increased, so that heat generated in the remaining workpieces on account of Joule heating is increased. Accordingly, the nugget is formed, or the formed nugget grows sufficiently large in size, at the interface between the remaining workpieces.

A seam welding method according to another aspect of the present invention is applied for seam-welding a layered body provided by layering three or more workpieces, a thinnest workpiece of the workpieces and having a smallest thickness being disposed on an outermost side of the layered body, the method including the steps of holding the layered body between the first roller electrode and the second roller electrode and bringing a pressurizing member into contact with the thinnest workpiece at a portion thereof different from a portion at which the first roller electrode contacts the thinnest workpiece, so as to pressurize the layered body by the pressurizing member from a side of the thinnest workpiece, and, while a pressure applied to the layered body by the first roller electrode and the pressurizing member and a pressure applied to the layered body by the second roller electrode are balanced, moving the first roller electrode, the second roller electrode and the current-branching electrode relative to the layered body, and applying an electric current between the first roller electrode and the second roller electrode.

Since the sum of pressures applied by the first roller electrode and the pressurizing member is balanced with respect to the pressure applied by the second roller electrode, the pressure applied by the first roller electrode is made small compared to the pressure applied by the second roller electrode. Accordingly, between the first roller electrode and the second roller electrode, which is substantially opposed to the first roller electrode, the pressure is distributed such that an acting range of the pressure widens from the first roller electrode toward the second roller electrode. Thus, the force acting on the thinnest workpiece and the workpiece adjacent thereto becomes smaller than the force acting at the interface between the remaining workpieces.

As a result of such a distribution, the contact area between the thinnest workpiece and the workpiece adjacent thereto is made smaller than the contact area between the remaining workpieces. Accordingly, contact resistance at the interface between the thinnest workpiece and the workpiece adjacent thereto can be increased, and as a result, heat generated on account of Joule heating can also be increased. Thus, the nugget generated at the interface can grow to a large size, thereby ensuring sufficient bonding strength between the thinnest workpiece and the workpiece adjacent thereto.

Further, since the thinnest workpiece is pressed by the pressurizing member, the thinnest workpiece is kept from becoming spaced apart from the workpiece adjacent thereto. Accordingly, the softened melted portion does not spatter off from the gap between the thinnest workpiece and the workpiece adjacent thereto.

Incidentally, the pressurizing member may be provided by the current-branching electrode, which is charged with a polarity opposite to that of the first roller electrode, so that a branch electric current from the first roller electrode to the current-branching electrode, or a branch electric current from the current-branching electrode to the first roller electrode, is generated when the electric current is applied.

A seam welding machine according to still another aspect of the present invention is applied for seam-welding a layered body provided by layering three or more workpieces, a thinnest workpiece of the workpieces and having a smallest thickness being disposed on an outermost side of the layered body, the machine including a first roller electrode in contact with the thinnest workpiece, a second roller electrode that holds the layered body in conjunction with the first roller electrode, and a current-branching electrode in contact with the thinnest workpiece, the current-branching electrode being charged with a polarity that is opposite to a polarity of the first roller electrode. When electric current is applied between the first roller electrode and the second roller electrode, which hold the layered body to perform seam welding, a branch electric current is generated from the first roller electrode to the current-branching electrode, or a branch electric current is generated from the current-branching electrode to the first roller electrode.

With the above arrangement, when the layered body is seam-welded, the branch electric current that flows in the thinnest workpiece and which is capable of sufficiently heating the thinnest workpiece and the workpiece adjacent thereto (i.e., an electric current flowing from the first roller electrode to the current-branching electrode, or an electric current flowing in the opposite direction) can be generated. Consequently, a nugget of sufficient size can be grown at the interface.

Further, in order to generate the branch electric current, it only is necessary to provide a current-branching electrode, and a displacement mechanism for displacing the current-branching electrode as required. Thus, the provision of the current-branching electrode does not make the structure of the machine significantly more complicated. Further, operations thereof can be controlled simply.

When a nugget is not formed at the interface, or if it is not necessary for the nugget to grow sufficiently between the remaining workpieces, then after only the current-branching electrode has been spaced apart from the thinnest workpiece, or the electric path between the current-branching electrode and the power source is disconnected, electric current may continue to be applied between the first roller electrode and the second roller electrode.

As a first arrangement for disconnecting only the electric path between the current-branching electrode and the power source, a common power source may be electrically connected to the first roller electrode, the second roller electrode and the current-branching electrode, and a switch for connecting or disconnecting only the electric path between the current-branching electrode and the power source may be provided between the current-branching electrode and the power source.

As an alternative arrangement, while a first power source is electrically connected with the first roller electrode and the second roller electrode, a second power source may be electrically connected with the first roller electrode and the current-branching electrode. In this case, it should be understood that the first power source and the second power source are adapted to apply or stop application of electric current independently of each other.

A seam welding machine according to a further aspect of the present invention is applied for seam-welding a layered body provided by layering three or more workpieces, a thinnest workpiece of the workpieces and having a smallest thickness being disposed on an outermost side of the layered body, the machine including a first roller electrode in contact with the thinnest workpiece, a second roller electrode that holds the layered body in conjunction with the first roller electrode, a pressurizing member in contact with a portion of the thinnest workpiece different from a portion at which the first roller electrode contacts the thinnest workpiece, the pressurizing member pressurizing the layered body from a side of the thinnest workpiece, a pressurizing mechanism that applies a pressure for pressurizing the layered body toward the pressurizing member, and a controller that controls the pressurizing mechanism. When electric current is applied between the first roller electrode and the second roller electrode, the controller balances a pressure applied to the layered body by the first roller electrode and the pressurizing member, and a pressure applied to the layered body by the second roller electrode.

According to the above arrangement, the pressure applied to the layered body by the first roller electrode and the second roller electrode can be distributed so that the acting range thereof becomes enlarged from the first roller electrode (the thinnest workpiece) to the second roller electrode. Consequently, contact resistance at the interface between the thinnest workpiece and the workpiece adjacent thereto can be increased, so that the interface can be sufficiently heated, so as to allow growth of a nugget of an appropriate size. Consequently, the bonding strength between the thinnest workpiece and the workpiece adjacent thereto can be increased.

In the above arrangement, the pressurizing member may be provided by a current-branching electrode, which is charged with a polarity opposite to that of the first roller electrode. Thus, when the electric current is applied, a branch electric current from the first roller electrode to the current-branching electrode, or a branch electric current from the current-branching electrode to the first roller electrode can be generated. As described above, in this arrangement, since the interface between the thinnest workpiece and the workpiece adjacent thereto is sufficiently heated due to the electric current from the first roller electrode to the current-branching electrode, or due to an electric current flowing in the opposite direction, a nugget can be grown to a sufficient size at the interface, thereby providing a bonding portion with excellent bonding strength.

As described above, in the present invention, the current-branching electrode, which is in contact with the thinnest workpiece disposed on an outermost side of the layered body, is used in addition to the first roller electrode and the second roller electrode, which hold the layered body. Electric current flowing via the thinnest workpiece is applied, in conjunction with the current-branching electrode, between the current-branching electrode and the first roller electrode that is in contact with the thinnest workpiece. Alternatively, in addition to the layered body being held by the first and second roller electrodes, the thinnest workpiece, which is disposed on the outermost side of the layered body, is pressed by the pressurizing member (preferably, the current-branching electrode) for thereby performing seam-welding.

Since seam-welding is conducted under the above conditions, the interface between the thinnest workpiece and the workpiece adjacent thereto can be heated sufficiently. Accordingly, a nugget, which is sufficiently large in size, can be grown at the interface, thereby bonding the thinnest workpiece and the workpiece adjacent thereto with a sufficient bonding strength.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic side elevational view showing the entirety of a seam welding machine according to a first exemplary embodiment;

FIG. 2 is a partially sectioned perspective view showing a seam welder of the seam welding machine;

FIG. 3 is a partially sectioned side elevational view showing the seam welder;

FIG. 4 is a front elevational view schematically showing a primary part of the seam welder;

FIG. 5 is a partially sectioned side elevational view showing the seam welder when an electric current starts to be applied thereto;

FIG. 6 is a pulse setting diagram schematically showing respective application times of electric current that flows through a layered body, and an electric current (branch electric current) that flows through an uppermost metal plate;

FIG. 7 is a partially sectioned side elevational view showing the seam welder when a branch electric current ceases to be applied thereto;

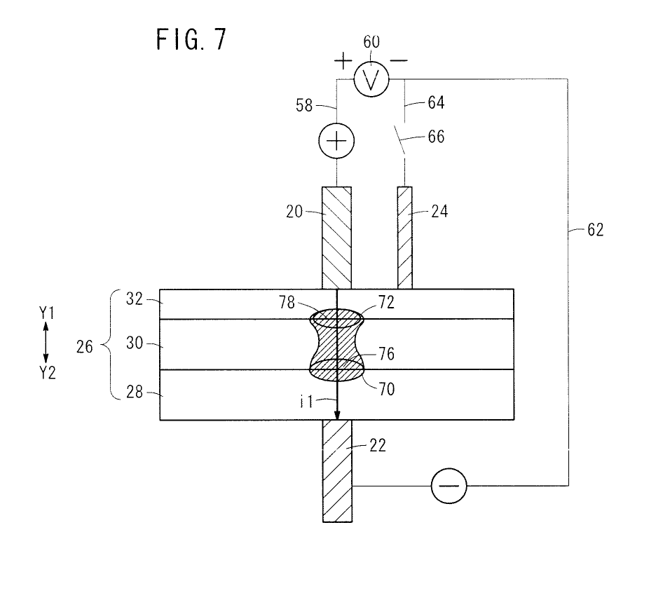

FIG. 8 is a partially sectioned side elevational view showing nuggets formed in the layered body;

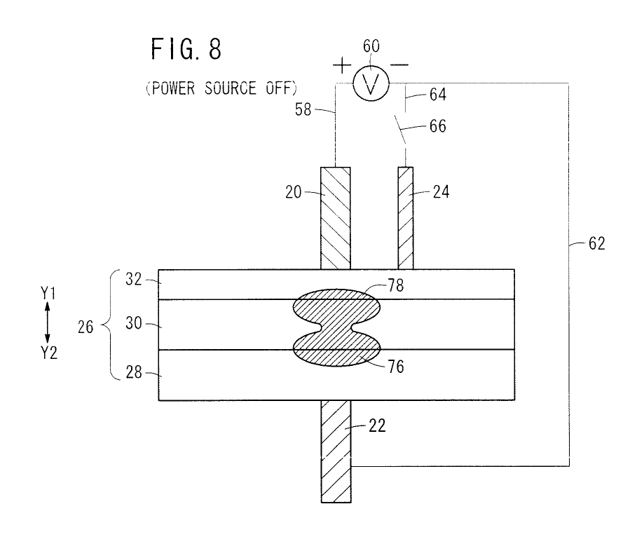

FIG. 9 is a side elevational cross sectional view showing a position at which nuggets are formed along a direction of movement of the layered body;

FIG. 10 is a partially sectioned perspective view showing a seam welder having an arrangement different from the seam welder shown in FIG. 2;

FIG. 11 is a partially sectioned side elevational view showing the seam welder shown in FIG. 10;

FIG. 12 is a front elevational view schematically showing a primary part of the seam welder shown in FIGS. 10 and 11;

FIG. 13 is an illustration showing electric wiring having an arrangement different from the electric wiring shown in FIG. 4;

FIG. 14 is another pulse setting diagram schematically showing respective application times of electric current that flows through the layered body, and an electric current (branch electric current) that flows through the uppermost metal plate;

FIG. 15 is a side elevational cross sectional view showing the position of nuggets formed along the direction of movement of the layered body when electric current is applied thereto as shown in FIG. 14;

FIG. 16 is yet another pulse setting diagram schematically showing respective application times of electric current that flows through the layered body, and an electric current (branch electric current) that flows through the uppermost metal plate; and

FIG. 17 is a side elevational cross sectional view showing the position of nuggets formed along the direction of movement of the layered body when electric current is applied thereto as shown in FIG. 15.

### DESCRIPTION OF THE PREFERRED EMBODIMENTS

With reference to the accompanying drawings, a detailed description of exemplary embodiments of a seam welding method according to the present invention will be described below, in conjunction with a seam welding machine for carrying out the seam welding method.

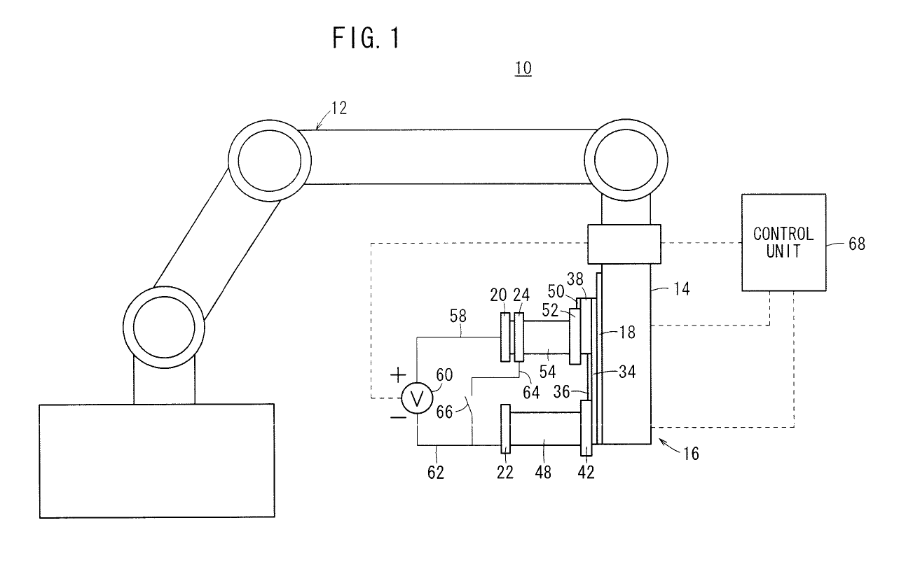

FIG. 1 is a schematic side elevational view showing a seam welding machine 10 in its entirety according to a first exemplary embodiment. The seam welding machine 10 includes a multi-joint robot 12 and a seam welder 16, which is supported on a distal arm 14 of the multi-joint robot 12. The components of the seam welding machine 10, which is made up by a combination of the multi-joint robot 12 and the seam welder 16, are well-known, as disclosed in Japanese Laid-Open Patent Publication No. 2007-167896 and Japanese Utility Model Registration No. 3124033. Accordingly, detailed explanations concerning the arrangement of such components will not be provided herein.

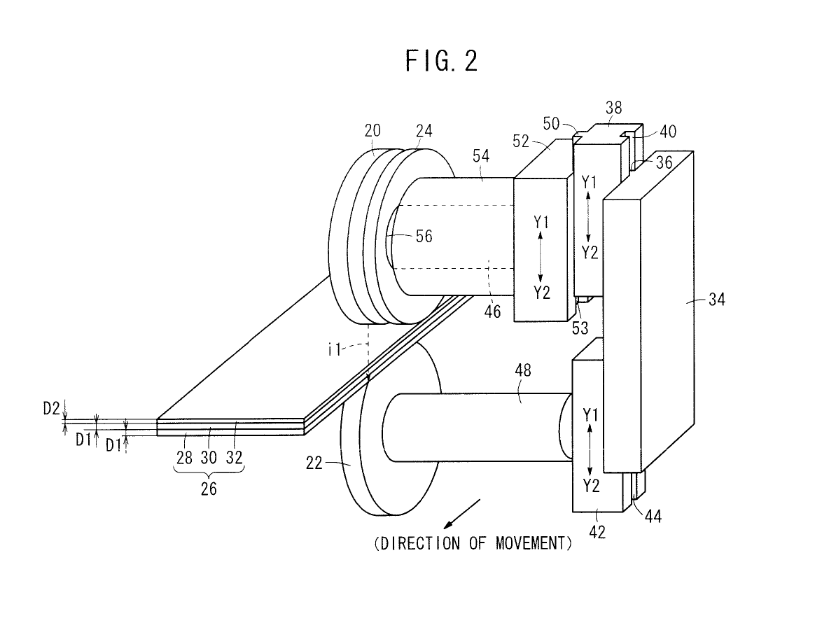

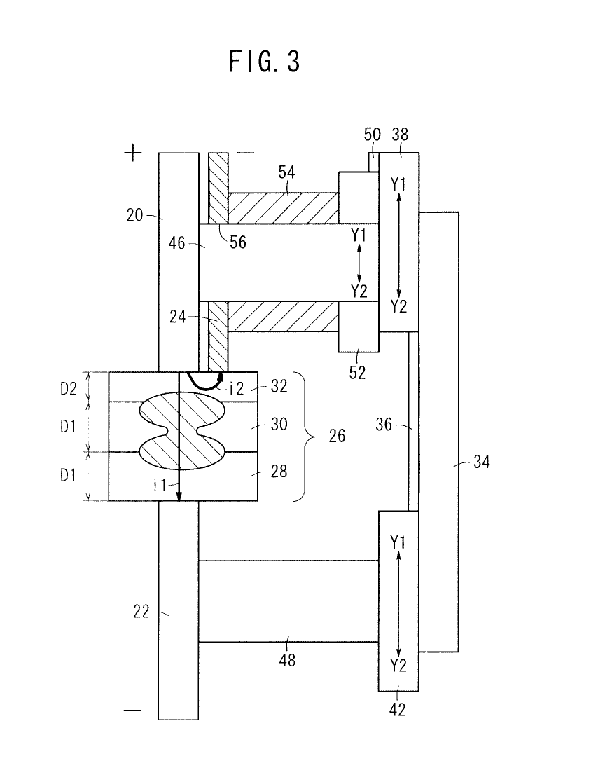

As shown in FIG. 2 (which is a partially sectioned perspective view) and FIG. 3 (which is a partially sectioned side elevational view), the seam welder 16 includes a first roller electrode 20, a second roller electrode 22, and a current-branching roller electrode 24 (current-branching electrode), which are supported on the distal arm 14 via a mount 18 (see FIG. 1). Among these components, the second roller electrode 22 is located at a lower side of a layered body 26, whereas the first roller electrode 20 and the current branching roller electrode 24 are disposed at an upper side of the layered body 26. In other words, the seam welder 16 holds the layered body 26 through a combination of the first roller electrode 20, the current-branching roller electrode 24, and the second roller electrode 22.

Initially, a brief explanation will be given below concerning the layered body 26 (object to be welded). In the exemplary embodiment, the layered body 26 is formed by laminating three metal plates 28, 30 and 32 in this order from below. The thickness of the metal plates 28 and 30 is set at D1 (e.g., approximately 1 to 2 mm). The thickness of the metal plate 32 is set at D2 (e.g., approximately 0.5 to 0.7 mm), which is smaller than the thickness D1. In other words, the metal plates 28 and 30 are of the same thickness, while the metal plate 32 is thinner than the metal plates 28 and 30. In the following descriptions, the metal plate 32 may occasionally be referred to as a thinnest workpiece.

Incidentally, the metal plates 28 and 30 comprise a material such as, for instance, JAC590, JAC780 or JAC980 (all being high-performance high-strength steel sheets, as specified by the Japan Iron and Steel Federation Standard). The thinnest workpiece 32 comprises a material such as, for instance, JAC270 (a high-performance steel sheet used for drawing).

On the other hand, the mount 18 is provided with a guide rail 34. In addition, the mount 18 is provided with a first cylinder for displacing the first roller electrode 20 both toward and away from the second roller electrode 22, a first rotary motor for rotating the first roller electrode 20, a second cylinder for displacing the second roller electrode 22 both toward and away from the first roller electrode 20, and a second rotary motor for rotating the second roller electrode 22. Such an arrangement is disclosed, for example, in Japanese Laid-Open Patent Publication No. 2007-167896. Thus, illustrations and detailed explanations thereof will not be provided herein. Incidentally, a servomotor may be provided in place of the first and second cylinders.

A recess 40 of a first movable table 38 that supports the first roller electrode 20, and a recess 44 of a second movable table 42 that supports the second roller electrode 22 are slidably engaged with a projection 36 of the guide rail 34. The first movable table 38 is connected to a first rod of the first cylinder (not shown). The second movable table 42 is connected to a second rod of the second cylinder (not shown).

In other words, the first roller electrode 20 is displaced in directions toward and away from the second roller electrode 22 (represented by arrows Y2 and Y1) in accordance with advancement and retraction of the first rod of the first cylinder. On the other hand, the second roller electrode 22 is displaced in directions toward and away from the first roller electrode 20 (represented by arrows Y1 and Y2) in accordance with advancement and retraction of the second rod of the second cylinder.

A first solid shaft 46 is provided between the first roller electrode 20 and the first movable table 38. The first rotary roller rotates the first solid shaft 46 in order to rotate the first roller electrode 20. Similarly, the second roller electrode 22 is rotated due to rotary movement of a second solid shaft 48, which is driven by the second rotary motor.

The first movable table 38 serves as a guide rail. More specifically, a recess 53 of a third movable table 52, which is connected to a third rod (not shown) of the third cylinder, is slidably engaged with a projection 50 that projects from a side of the first movable table 38. Accordingly, the current-branching roller electrode 24 is displaceable in directions toward and away from the second roller electrode 22 (in directions represented by the arrows Y2 and Y1), in accordance with advancement and retraction of the third rod.

A hollow shaft 54 is provided between the current-branching roller electrode 24 and the third movable table 52. Further, a through-hole 56 is provided in the current-branching roller electrode 24 along the thickness direction thereof. The first solid shaft 46 is inserted into the hollow shaft 54, with one end thereof being exposed through the through-hole 56 of the current-branching roller electrode 24.

A predetermined clearance is established between the first roller electrode 20 and the current-branching roller electrode 24 (see, in particular, FIGS. 1 and 3). Thus, the first roller electrode 20 and the current-branching roller electrode 24 do not come into contact with each other.

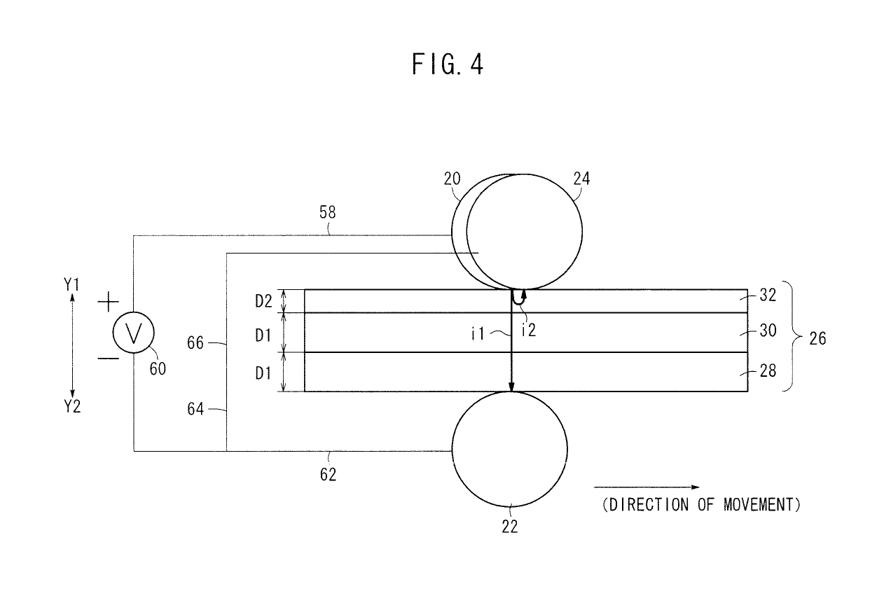

As shown in FIG. 4, which illustrates a schematic front elevation of a primary part of the first exemplary embodiment, the first roller electrode 20 is electrically connected to a positive electrode of an AC source 60 via a first lead wire 58, the second roller electrode 22 is electrically connected to a negative electrode of the AC source 60 via a second lead wire 62, and the current-branching roller electrode 24 is electrically connected to the negative electrode of the AC source 60 via a third lead wire 64, which branches off from the second lead wire 62. As can be understood from the above, although both the first roller electrode 20 and the current-branching roller electrode 24 are in contact with the thinnest workpiece 32 of the layered body 26, the polarities of the first roller electrode 20 and the current-branching roller electrode 24 are opposite to one another respectively.

An ON/OFF switch 66 is provided in the third lead wire 64. The ON/OFF switch 66 is switched on and off in order to supply or stop the supply of electric current to the current-branching roller electrode 24, independently of the first and second roller electrodes.

In the above arrangement, the first to third cylinders, the first to third rotary motors, the AC source 60, and the ON/OFF switch 66 are electrically connected to a control unit (controller) 68 (see FIG. 1). In other words, operations and/or actuation of the first to third cylinders, the first to third rotary motors, the AC source 60, and the ON/OFF switch 66 are controlled through the control unit 68.

The seam welding machine 10 according to the first exemplary embodiment includes the seam welder 16 having the basic arrangement as described above. Next, operations of the seam welding machine 10 will be described below, in conjunction with the seam welding method according to the first exemplary embodiment.

When the layered body 26 is seam-welded, in other words, when the metal plates 28 and 30 are bonded simultaneously upon bonding of the metal plates 30 and 32, the distal arm 14 (i.e., the seam welder 16) is moved so that the layered body 26 is located between the first roller electrode 20 and the second roller electrode 22.

Subsequently, the first cylinder and the second cylinder are actuated under the control of the control unit 68, so that the first rod and the second rod start to advance. More specifically, the second roller electrode 22 is displaced toward the first roller electrode 20 in the direction of the arrow Y1. Simultaneously, the first roller electrode 20 is displaced toward the second roller electrode 22 in the direction of the arrow Y2. As a result, the layered body 26 is held between the first roller electrode 20 and the second roller electrode 22.

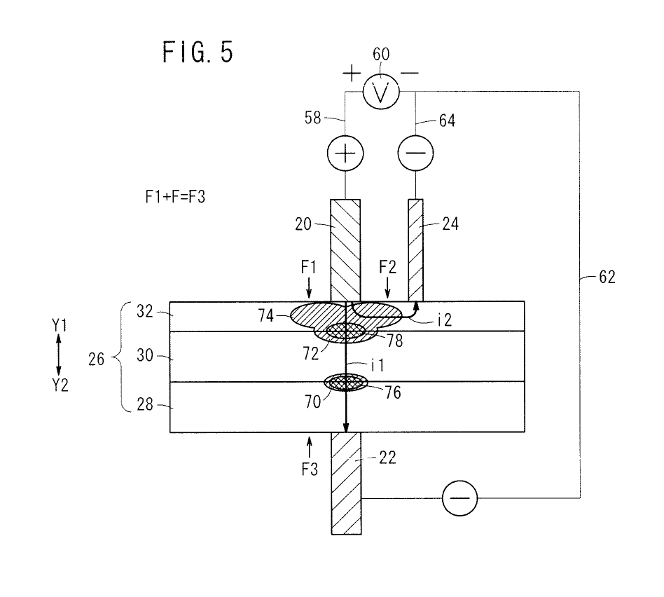

On the other hand, the control unit 68 actuates the third cylinder. Such actuation causes the third rod to be advanced in the direction of the arrow Y2. As a result, the current-branching roller electrode 24 abuts against the thinnest workpiece 32 at or around the time that the first roller electrode 20 and the second roller electrode 22 hold the layered body 26. FIG. 5 is a schematic side elevational view showing the condition at that time.

Incidentally, although the ON/OFF switch 66 is not illustrated in FIG. 5, the state of the ON/OFF switch 66, which is switched on to become electrically connected to the negative electrode of the AC source 60, is represented by a minus sign (“−”).

The control unit 68 controls the thrust forces of the first rod of the first cylinder and the third rod of the third cylinder, as well as the thrust force of the second rod of the second cylinder, so that the sum of the pressures (F1+F2) applied respectively by the first roller electrode 20 and the current-branching roller electrode 24 against the thinnest workpiece 32 is balanced with the pressure (F3) applied by the second roller electrode 22 against the metal plate 28. Under such a control, the pressure applied in the direction of the arrow Y1 (F1+F2) is substantially equalized with the pressure applied in the direction of the arrow Y2 (F3).

In other words, an inequality F1<F3 is established at this time. Accordingly, the force received by the layered body 26 from the first roller electrode 20 and the second roller electrode 22 is distributed, such that the acting range becomes widened (enlarged) from the second roller electrode 22 toward the first roller electrode 20. Thus, the force acting at the interface between the metal plate 30 and the metal plate 32 is made smaller than the force acting at the interface between the metal plate 28 and the metal plate 30.

On the other hand, supposing that F1 is equalized with F3 (F1=F3) without using the current-branching roller electrode 24, the force received by the layered body 26 from the first roller electrode 20 and the second roller electrode 22 is made uniform throughout from the second roller electrode 22 to the first roller electrode 20. In other words, the force acting at the interface between the metal plates 30 and 32 becomes equalized with the force acting at the interface between the metal plates 28 and 30.

As described above, the force-acting range when F1 is smaller than F3 (F1<F3) is narrower than the force-acting range when F1 is equal to F3 (F1=F3). This implies that, when F1 is smaller than F3, the area of the thinnest workpiece 32 that presses against the metal plate 30 is narrower than when F1 is equal to F3, or in other words, the thinnest workpiece 32 is in contact with the metal plate 30 over a smaller contact area.

Such a distribution of pressure from the first roller electrode 20 and the second roller electrode 22, and the reduction in contact area between the metal plate 30 and the thinnest workpiece 32, results in a reaction force from the layered body 26 toward the first roller electrode 20. In the first exemplary embodiment, the reaction force is received by the current-branching roller electrode 24.

Next, the control unit 68 turns on the ON/OFF switch 66 and starts to apply electric current to the layered body 26 from the AC source 60. As described above, since the first roller electrode 20 and the second roller electrode 22 are connected respectively to the positive and negative electrodes of the AC source 60, an electric current i1 flows from the first roller electrode 20 toward the second roller electrode 22, as shown in FIGS. 3 to 5.

As described above, the current-branching roller electrode 24, which is negatively charged, also is in contact with the thinnest workpiece 32. Accordingly, a branch electric current i2, which flows from the first roller electrode 20 toward the current-branching roller electrode 24, is generated simultaneously with generation of the electric current i1.

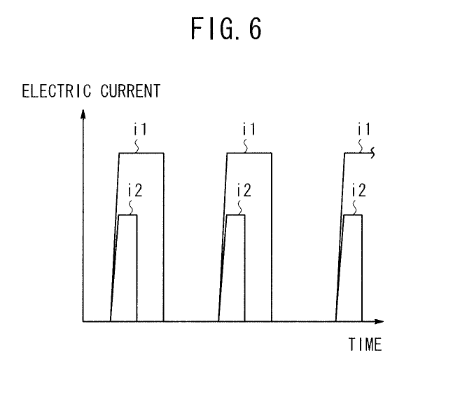

The control unit 68 applies a pulse setting to the AC source 60 and turns the ON/OFF switch 66 on and off, such that the application time of the electric current i1 becomes shorter than the application time of the electric current i2, as shown in FIG. 6. During the above period, interfaces between the metal plates 28 and 30, and between the metal plates 30 and 32 are heated by Joule heating, which is generated by the electric current i1, thereby forming respective heated areas, as shown in FIG. 5.

As described above, the contact area between the thinnest workpiece 32 and the metal plates 30 when the sum of F1 and F2 is equal to F3 (F1+F2=F3) (i.e., when F1<F3) is smaller than the contact area between the thinnest workpiece 32 and the metal plate 30 when F1 is equal to F3 (i.e., when F2=0). Accordingly, when F1 is smaller than F3, the contact resistance and current density at the interface between the metal plates 30 and 32 is greater than when F1 is equal to F3. Accordingly, when F1 is smaller than F3, the amount of Joule heating (i.e., resistance heating) becomes larger than when F1 is equal to F3. Thus, a heated area 70 at the interface between the metal plates 28 and 30 and a heated area 72 at the interface between the metal plates 30 and 32 expand so as to be of substantially the same size.

At this time, the thinnest workpiece 32 is pressed toward the metal plates 30 by the current-branching roller electrode 24. Since the thinnest workpiece 32 is pressed toward the metal plate 30, the thinnest workpiece 32, which is low in rigidity, is kept from warping in accordance with application of electric current (heating), and therefore is prevented from becoming spaced apart from the metal plate 30. Thus, spattering of the softened melted portion can be prevented from occurring at the spaced portion between the thinnest workpiece 32 and the metal plate 30.

When the electric current i1 starts to flow, the branch electric current i2 also flows from the first roller electrode 20 toward the current-branching roller electrode 24. Thus, in the first exemplary embodiment, the branch electric current i2 is generated, which flows at least to the thinnest workpiece 32 without flowing to the lowermost metal plate 28. As a result, electric current passing through the interior of the thinnest workpiece 32 increases, as compared to a typical seam welding method in which only the first roller electrode 20 and the second roller electrode 22 are used.

Thus, in addition to the heated area 72, another heated area 74 is formed inside the thinnest workpiece 32. The heated area 74 becomes enlarged over time so as to become united with the heated area 72. Consequently, heat is transmitted to the interface between the metal plates 30 and 32 from the united heated areas 72 and 74.

The heated area 70 heats the interface between the metal plates 28 and 30. Simultaneously therewith, the heated areas 72 and 74, which have been formed in the foregoing manner, heat the interface between the metal plates 30 and 32. Consequently, the temperature at the interfaces increases sufficiently to result in melting thereof.

Subsequently, the control unit 68 turns the ON/OFF switch 66 off. Since the branch electric current i2 is extinguished when the ON/OFF switch 66 is turned off, only the electric current i1, which flows from the first roller electrode 20 toward the second roller electrode 22, is applied to the thinnest workpiece 32. As a result, the heated area 74 (see FIG. 5) vanishes.

Instead of turning off the ON/OFF switch 66, the third rod of the third cylinder may be retracted in the direction of the arrow Y1, so as to separate the current-branching roller electrode 24 from the thinnest workpiece 32 and thereby cause the branch electric current i2 to disappear.

On the other hand, the metal plates 28, 30 and 32 are in a condition similar to that utilized in typical seam welding. In other words, the amount of heat generated due to Joule heating increases in the thick metal plates 28 and 30, so that the heated area 70 becomes enlarged, and the temperature at the heated area 70 is raised. The heated area 70, the temperature of which has been raised, heats the interface between the metal plates 28 and 30, so that the temperature at the portion adjacent to the interface increases sufficiently and is further melted.

Subsequently, the layered body 26 and/or the distal arm (see FIG. 1) is moved, whereby the layered body 26 is moved relative to the first roller electrode 20, the second roller electrode 22, and the current-branching roller electrode 24, thereby shifting the electric path. In other words, the electric current is shifted away from the melted portion, so as to terminate generation of Joule heating at the melted portion.

Thus, the temperature at the melted portion is lowered, and the melted portion ultimately becomes solidified to form nuggets 76 and 78 between the metal plates 28 and 30, and between the metal plates 30 and 32, respectively. According to the above process, a bonded product can be obtained, in which the metal plates 28, 30 and the metal plates 30, 32 are mutually bonded.

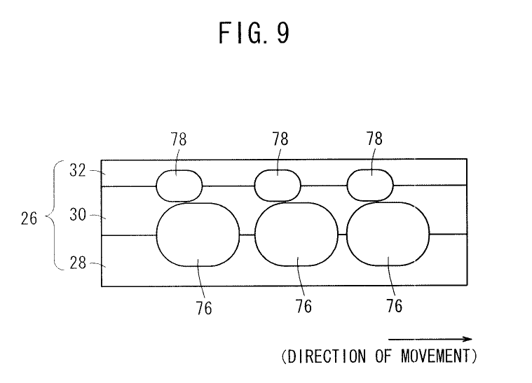

Incidentally, in the first exemplary embodiment, in which the application time of the electric current i1 and the branch electric current i2 is controlled as shown in FIG. 6, the nuggets 76 and 78 are formed along the direction of movement of the layered body 26, as shown in FIG. 9. The nuggets 76 and 78 may also be continuously formed in some cases.

As described above, the interface between the metal plates 30 and 32 is heated sufficiently due to formation of the heated areas 72 and 74. Thus, the interface between the metal plates 28 and 30 is melted approximately at the same level as that of the interface between the metal plates 28 and 30, where large resistance heating causes a rigid nugget 78 to be formed. Accordingly, the obtained bonded product exhibits excellent bonding strength between the metal plates 30 and 32, similar to the bonding strength between the metal plates 28 and 30. This is due to the fact that the nugget 78, which is formed between the metal plates 30 and 32, grows sufficiently in accordance with a sufficient amount of Joule heating, which is generated at the interface between the metal plates 30 and 32.

As described above, according to the first exemplary embodiment, while generation of spattering is avoided, a nugget 78 of approximately the same size as the nugget 76 formed between the metal plates 28 and 30 can be grown between the metal plates 30 and 32, thereby providing a bonded product that exhibits excellent bonding strength between the metal plates 30 and 32.

Further, as can be understood from the above, the seam welding machine 10 according to the first exemplary embodiment only requires the current-branching roller electrode 24 together with a displacement mechanism (e.g., a cylinder, a servomotor or the like) for displacing the current-branching roller electrode 24. Accordingly, the structure of the seam welding machine 10 is not made complex on account of providing the current-branching roller electrode 24.

It should be understood that, in the above exemplary embodiment, although the sum of the pressures (F1+F2) applied by the first roller electrode 20 and the current-branching roller electrode 24 is balanced, for example, with the pressure (F3) applied to the metal plate 28 by the second roller electrode 22, it is not required to balance pressures in the first exemplary embodiment, in which the branch electric current i2 is applied.

Incidentally, although the first exemplary embodiment employs the current-branching roller electrode 24 as a pressurizing member, a simple pressurizing member, which does not serve as an electrode (e.g., an elongated stick-shaped rod or an annular ring body) may be used in a second exemplary embodiment.

In the second exemplary embodiment, while electric current is applied from the first roller electrode 20 only to the second roller electrode 22, the thinnest workpiece 32 is pressed by the pressurizing member, which is disposed on the side of the thinnest workpiece 32 (i.e., on the same side as the first roller electrode 20). At this time, the control unit 68 controls the thrust force of the first, second and third rods of the first through third cylinders, so that the sum of the pressures (F1+F2) applied to the thinnest workpiece 32 by the first roller electrode 20 and the pressurizing member is balanced with the pressure (F3) applied on the lowermost metal plate 28 by the second roller electrode 22.

In the second exemplary embodiment, which uses the pressurizing member to balance the pressures applied when the layered body 26 is held, simply by applying the electric current i1 from the first roller electrode 20 to the second roller electrode 22, the respective sizes of the nugget 76 formed between the metal plates 28 and 30 and the nugget 78 formed between the metal plates 30 and 32 can be substantially equalized.

When the current-branching roller electrode 24 is electrically insulated from the AC source 60, for example, by constantly turning off the ON/OFF switch 66 in the seam welding machine 10 according to the first exemplary embodiment, the seam welding method according to the second exemplary embodiment can be performed. In other words, in the arrangement of the seam welding machine 10 according to the first exemplary embodiment, the seam welding method and seam welding machine 10 according to the first exemplary embodiment, and the seam welding method and seam welding machine according to the second exemplary embodiment can be selected, simply by selecting whether an electric current is applied to the current-branching roller electrode 24 or not. The above-noted phrase, “simple pressurizing member, which does not serve as an electrode,” implies and includes the component that does not function as an electrode, as described above.

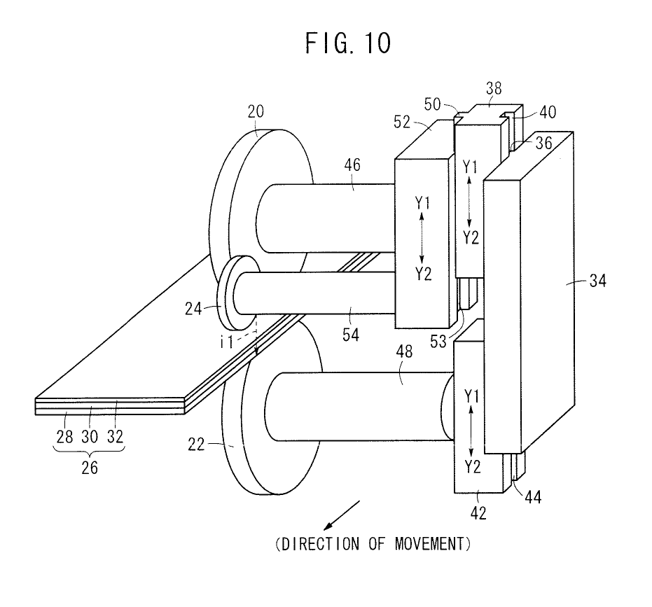

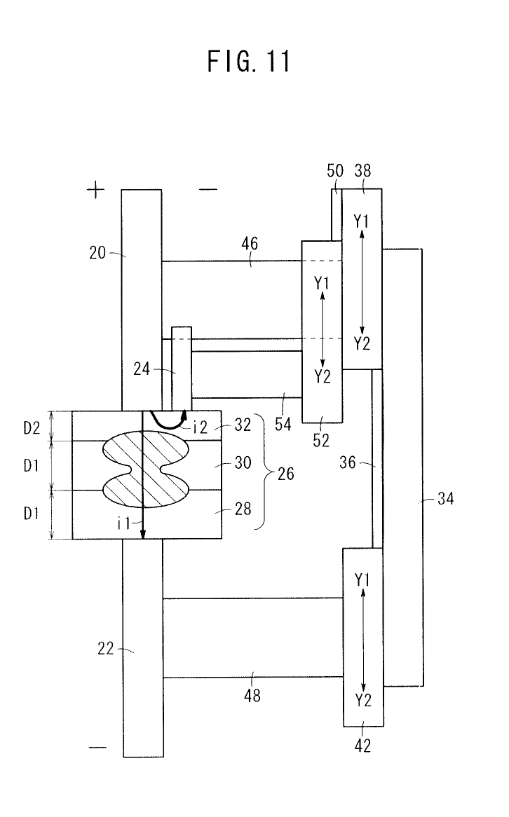

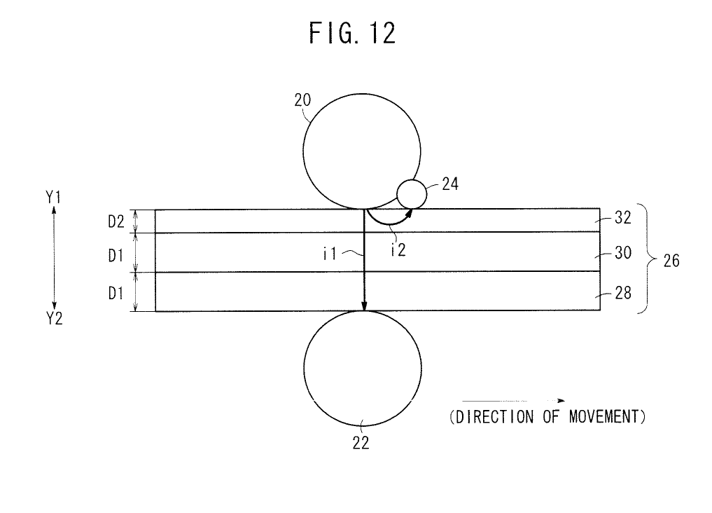

Further, in both of the first and second exemplary embodiments, the first solid shaft 46 and the hollow shaft 54 may be spaced apart from each other, as shown in FIGS. 10 and 11, and the current-branching roller electrode 24 may be disposed on a lateral side of the first roller electrode 20, as shown in FIG. 12. It should be understood that the current-branching roller electrode 24 may also be supported by a solid shaft, instead of the hollow shaft 54.

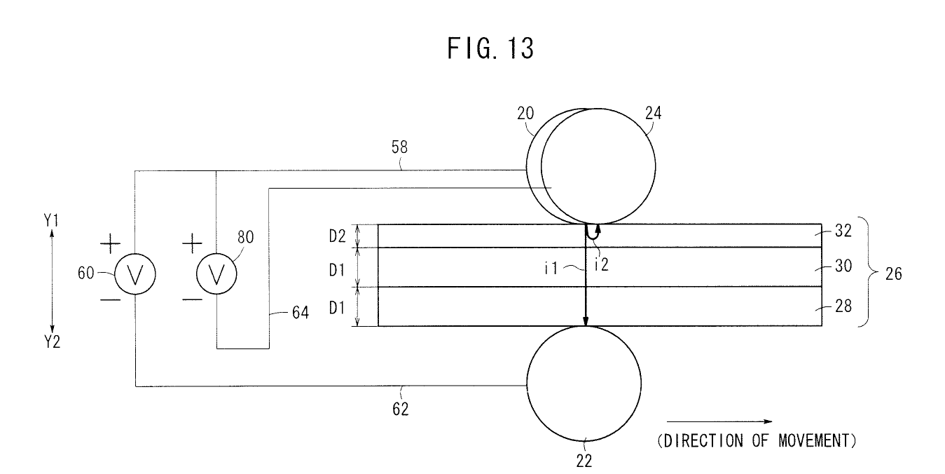

Further, instead of the ON/OFF switch 66, an AC source 80, which is independent of the AC source 60, may be provided in the third lead wire 64, as shown in FIG. 13. In this case, by shortening the pulse intervals (current supply time) of the AC source 80, as compared to the AC source 60, the electric current i1 and the branch electric current i2 can be applied as shown in FIG. 6.

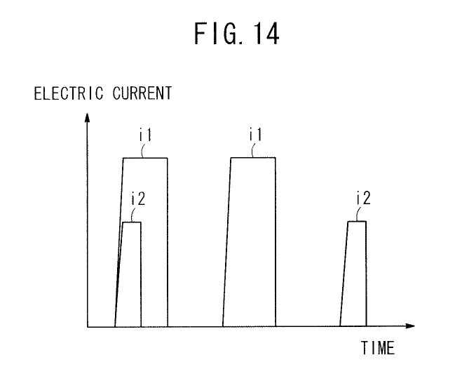

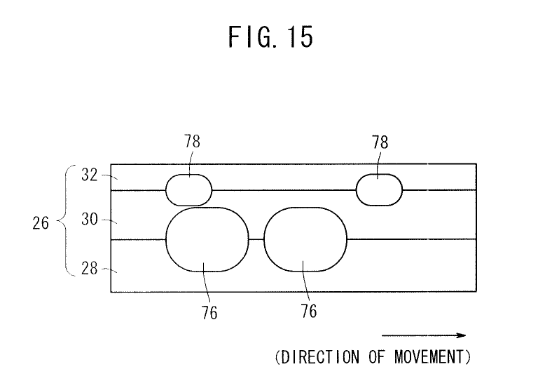

Furthermore, in either of the electrical arrangements shown in FIGS. 4 and 13, the electric current i1 and the branch electric current i2 may be applied according to pulse intervals, as shown in FIG. 14. In this case, the nuggets 76 and 78 grow along the direction of movement of the layered body 26, as shown in FIG. 15. Alternatively, the nuggets 76 and 78 may be formed continuously.

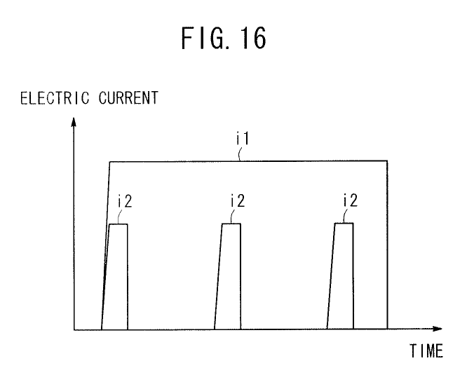

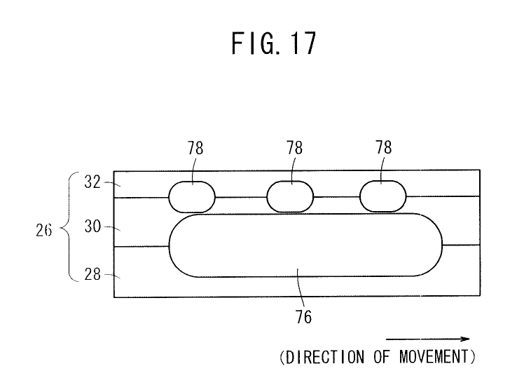

Alternatively, the electric current i1 may be applied continuously while the branch electric current i2 is applied in pulses, as shown in FIG. 16. In this case, while the electric current is applied continuously at the contact interface between the metal plates 28 and 30, the branch electric current i2 is intermittently applied at the inside of the thinnest workpiece 32. Accordingly, as shown in FIG. 17, the nugget 76, which extends linearly along the relative direction of movement of the layered body 26, is formed at the contact interface between the metal plates 28 and 30, while a plurality of nuggets 78 are formed intermittently at the contact interface between the metal plates 30 and 32. In other words, the metal plates 28 and 30 are linearly bonded, whereas the metal plates 30 and 32 are bonded in a dotted manner.

By altering the bonding configurations in the aforementioned manner, an appropriate bonding strength, in accordance with the metal type or the thickness of the metal plates 28, 30 and 32, can be obtained.

Further, alternatively, in contradistinction to the above exemplary embodiments, an electric current may be applied from the second roller electrode 22, which is in contact with the lowermost metal plate 28, toward the first roller electrode 20, which is in contact with the uppermost thinnest workpiece 32. In such an arrangement, the polarity of the current-branching roller electrode 24, which is in contact with the thinnest workpiece 32, is set to be opposite to that of the first roller electrode 20. In other words, while the second roller electrode 22 and the current-branching roller electrode 24 are electrically connected to the positive electrode of the AC source 60, the first roller electrode 20 is connected electrically to the negative electrode of the AC source 60. With the above arrangement, an electric current i1 is generated, which flows from the second roller electrode 22 toward the first roller electrode 20, and a branch electric current i2 is generated, which flows from the current-branching roller electrode 24 toward the first roller electrode 20.

Further, alternatively, it is a matter of course that the layered body 26 may be made up of four or more metal plates.

In either of the first exemplary embodiment or the second exemplary embodiment, the branch electric current i2 may be applied not only to the thinnest workpiece 32, but also to the metal plate 30, which is positioned immediately below the thinnest workpiece 32.

Although certain preferred embodiments of the present invention have been shown and described in detail, it should be understood that various changes and modifications may be made therein without departing from the scope of the appended claims.

What is claimed is:

1. A seam welding method for seam-welding a layered body provided by layering three or more workpieces, a thinnest workpiece of the workpieces and having a smallest thickness being disposed on an outermost side of the layered body, the method comprising the steps of:
holding the layered body between a first roller electrode and a second roller electrode and bringing a current-branching electrode into contact with the thinnest workpiece, the current-branching electrode being charged with a polarity that is opposite to a polarity of the first roller electrode that is in contact with the thinnest workpiece; and
while moving the first roller electrode, the second roller electrode and the current-branching electrode relative to the layered body, applying an electric current between the first roller electrode and the second roller electrode to thereby seam-weld the layered body, and applying a branch electric current from the first roller electrode to the current-branching electrode or from the current-branching electrode to the first roller electrode.

2. The welding method according to claim 1, wherein, while the electric current is applied between the first roller electrode and the second roller electrode, only the current-branching electrode is spaced apart from the thinnest workpiece in order to stop applying the branch electric current.

3. The welding method according to claim 1, wherein, while the electric current is applied between the first roller electrode and the second roller electrode, only an electric path between the current-branching electrode and a power source is disconnected in order to stop applying the branch electric current.

4. A seam welding method for seam-welding a layered body provided by layering three or more workpieces, a thinnest workpiece of the workpieces and having a smallest thickness being disposed on an outermost side of the layered body, the method comprising the steps of:
holding the layered body between the first roller electrode and the second roller electrode and bringing a pressurizing member into contact with the thinnest workpiece at a portion thereof different from a portion at which the first roller electrode contacts the thinnest workpiece, so as to pressurize the layered body by the pressurizing member from a side of the thinnest workpiece; and
while a pressure applied to the layered body by the first roller electrode and the pressurizing member and a pressure applied to the layered body by the second roller electrode are balanced, moving the first roller electrode, the second roller electrode and the current-branching electrode relative to the layered body, and applying an electric current between the first roller electrode and the second roller electrode.

5. The welding method according to claim 4, wherein the pressurizing member comprises a current-branching electrode having a polarity opposite to a polarity of the first roller electrode and, when the electric current is applied, a branch electric current from the first roller electrode to the current-branching electrode, or a branch electric current from the current-branching electrode to the first roller electrode is generated.

6. A seam welding machine for seam-welding a layered body provided by layering three or more workpieces, a thinnest workpiece of the workpieces and having a smallest thickness being disposed on an outermost side of the layered body, the machine comprising:
a first roller electrode in contact with the thinnest workpiece;
a second roller electrode that holds the layered body in conjunction with the first roller electrode; and
a current-branching electrode in contact with the thinnest workpiece, the current-branching electrode being charged with a polarity that is opposite to a polarity of the first roller electrode,
wherein, when the electric current is applied between the first roller electrode and the second roller electrode, which hold the layered body to perform seam welding, a branch electric current is generated from the first roller electrode to the current-branching electrode, or a branch electric current is generated from the current-branching electrode to the first roller electrode.

7. The machine according to claim 6, further comprising:
a single power source electrically connected to the first roller electrode, the second roller electrode and the current-branching electrode; and
a switch provided between the current-branching electrode and the power source, the switch connecting or disconnecting only an electric path between the current-branching electrode and the power source.

8. The machine according to claim 6, further comprising:
a first power source electrically connected to the first roller electrode and the second roller electrode; and
a second power source electrically connected to the first roller electrode and the current-branching electrode, the first power source and the second power source being capable of independently applying and stopping application of the electric current.

9. A seam welding machine for seam-welding a layered body provided by layering three or more workpieces, a thinnest workpiece of the workpieces and having a smallest thickness being disposed on an outermost side of the layered body, the machine comprising:
a first roller electrode in contact with the thinnest workpiece;
a second roller electrode that holds the layered body in conjunction with the first roller electrode;
a pressurizing member in contact with a portion of the thinnest workpiece different from a portion at which the first roller electrode contacts the thinnest workpiece, the pressurizing member pressurizing the layered body from a side of the thinnest workpiece;
a pressurizing mechanism that applies a pressure for pressurizing the layered body toward the pressurizing member; and
a controller that controls the pressurizing mechanism,
wherein, when the electric current is applied between the first roller electrode and the second roller electrode, the controller balances a pressure applied to the layered body by the first roller electrode and the pressurizing member, and a pressure applied to the layered body by the second roller electrode.

10. The machine according to claim 9, wherein the pressurizing member comprises a current-branching electrode, which is charged with a polarity opposite to a polarity of the first roller electrode, such that, when the electric current is applied, a branch electric current from the first roller electrode to the current-branching electrode, or a branch electric current from the current-branching electrode to the first roller electrode is generated.
